(19) United States
(12) Patent Application Publication
(10) Pub. No.: US 2026/0085604 A1
(43) Pub. Date: Mar. 26, 2026

(54) OVERFLOW DETECTION AND PREVENTION METHODS

(71) Applicant: DRILLDOCS COMPANY, Houston, TX (US)

(72) Inventors: Martin E. OEHLBECK, Cohocton, NY (US); Francois Ruel, Victoriaville (CA); Calvin Stuart Holt, Houston, TX (US)

(21) Appl. No.: 19/473,725

(22) PCT Filed: May 17, 2024
(86) PCT No.: PCT/US2024/030065

§ 371 Date: Oct. 8, 2025

Related U.S. Application Data
(60) Provisional application No. 63/467,555, filed on May 18, 2023.

(51) Int. Cl. E21B 47/002; G06N 3/045; G06V 10/25

(52) U.S. Cl. CPC E21B 47/0025; G06N 3/045; G06V 10/25

(57) ABSTRACT

Systems methods are provided to detect potential overflow events, inhibit such overflow events, and take action to remediate damage caused by overflow events at a drill rig. For example, in situ instrumentation and image detection technology may be used to predict, inhibit, and remediate overflows at Mechanical Mud Separation Machines. Various actions may be taken based on the likelihood of occurrence of an overflow event. For example, drilling operational parameters may be adjusted. Additionally, vision system parameters may also be adjusted.

### RELATED APPLICATIONS

This application claims priority to and the benefit of U.S. Provisional Ser. No. 63/467,555 , which was filed on May 18, 2023, titled “OVERFLOW DETECTION AND PREVENTION METHODS”, the disclosure of which is hereby incorporated by reference in its entirety.

### BACKGROUND

During wellbore formation, mechanical mud separation machines (“MMSMs”) such as shaker tables are often employed to separate drilling solids from drilling liquids. Drilling fluid may be recycled as part of the drilling operation, and the solids may be analyzed to determine various wellbore and operational features of the wellbore and the drill rig.

In many wellbore operations, it is desirous to optimize MMSM separation capabilities to maximize drilling fluid recovery while minimizing equipment wear, such as wear from dry solids. Adjustments may be made to various MMSM parameters and other drilling parameters to achieve a relatively high level of separation optimization. For example, adjustments to table angle, screen type, flow rate, vibration force, fluid rheology, and speed may be made. However, for many separation applications, it is important to maintain the MMSM parameters and drilling parameters at a level so as not to cause an overflow event. Such overflow events are typically characterized by drilling fluid spilling over the side walls of the shaker table.

For some applications, this means setting MMSM parameters and other drilling parameters at a level such that a portion of the shaker table is relatively free from drilling liquid. By way of specific example, some operating manuals of MMSMs describe setting MMSM parameters and operational parameters to allow about 6-8″ at the output of the shaker to be relatively free of fluid when using water-based separation fluid and about 10-15″ when using oil-based separation fluid. While this may result in a less efficient separation (e.g., it may take longer to separate objects from the drilling fluid), leaving a portion of the shaker relatively dry helps mitigate against accidental overflow. For example, when the flow unintentionally surges, the free space on the shaker may help absorb the flow surge.

As drilling fluid flows over the screens of the MMSMs, however, debris tends to obstruct the holes in the screen. These obstructions result in less efficient separation and, in some instances, can cause the drilling fluid to overflow from the Mechanical Mud Separation machine. Often, overflow occurs suddenly and goes unnoticed for a period of time. In many cases, an overflow event causes the loss of otherwise reusable and expensive drilling fluid and results in environmental damage as well as significant lost operational drilling time.

Many shaker table operations use manual visual observation to identify shaker tables on the verge of overflow. For example, shaker table operators may watch the liquid content on various portions of the shaker table to determine whether a shaker table is overflowing or about to overflow. However, doing so requires extensive manpower and relies on the operator's attention span, knowledge, and reaction speed, who may not be solely dedicated to this task. Thus, manual observation is unreliable and expensive and leads to avoidable economic loss and environmental damage.

There have been attempts to automate this process. Such attempts rely on using cameras and computer systems to identify a boundary between a wet portion of a screen and a dry portion of a screen. These attempts may also control the shaker table parameters to position this boundary actively. Such reliance, however, has several drawbacks. For example, in an overflow scenario, there may not be a discernible boundary between the wet and dry zone, especially during sudden or tumultuous events. Additionally, in a plugging or blinding scenario, there may not be a clear discernable boundary. Further, reliance on boundary detection may be unnecessary, especially when other indicators of an overflow event are present. Thus, wet-dry boundary detection schemes often fail to detect overflow events and perform unnecessary computations with unnecessary equipment complexity in a hostile environment. U.S. Pat. Nos. 10,643,322 and 9,908,148 disclose automated systems that replicate these and other problems.

It is with respect to these and other considerations that the technologies described below have been developed. Also, although relatively specific problems have been discussed, it should be understood that the embodiments should not be limited to solving the specific problems identified in the introduction.

### BRIEF SUMMARY

It is to be understood that both the foregoing introduction and the following detailed description are exemplary and explanatory and are intended to provide further explanation of the innovative technologies as claimed. This summary is not intended to limit the scope of the innovative technologies described herein.

The technology generally relates to improving drilling operations at a drill rig. Aspects of the technology relate to using various in situ instrumentation and image detection technology to predict the likelihood of an overflow event occurring. Various actions may be taken based on the likelihood of occurrence. For example, drilling operational parameters may be adjusted. This may include adjusting the pumping speed of fluid, speed of drill, weight on bit, fluid pressure, and fluid rheology. Additionally, adjustments may be made to increase the rate of penetration (e.g., if the likelihood of overflow is very low, the rate of penetration may be increased) or decrease/stop the rate of penetration (e.g., in the event that the likelihood of penetration is beyond a predetermined limit, the rate of penetration may be slowed or stopped).

Aspects of the technology include a computer-implemented method. The method includes capturing a field of view of a MMSM using an image capture device. The method further includes determining a first region of interest within the field of view based on shaker table features. In examples, the first region of interest comprises image data. The method may also include determining, using a Deep Neural Network, whether the image data indicates the region captured by the first region of interest is relatively dry. The method may further include taking an action based on the determining of whether the image data indicates the region is relatively dry or flooded.

In examples. the computer-implemented may determine whether the image data indicates the region is relatively dry by, in part, determining that the region is not relatively dry. In examples, taking an action comprises taking a remedial action. The remedial action may be selected from the group consisting of sounding an audible alarm, setting a visual alarm, sending an error message, sending a control signal to initiate a spray wash, sending a control signal to initiate a spray wash pressure, washing screens, changing pump rate, changing a fluid property, sending a message indicating to change screen size, type, or replace screens.

In examples, determining the first region of interest comprises identifying an object in the region of interest with a known dimension, correlating the known dimension to a number of pixels, and selecting the first region of interest to be a first number of pixel in height and a second number of pixels in length based on the correlation. In additional/alternative examples, the first region of interest dimensions are determined from pre-existing data. In additional/alternative examples, the pre-existing data was received by a user entering information into a graphical user interface of a computing device. Methods may further include capturing an other region of interest. The other region of interest may be a falling zone of an MMSM. In further examples, the other region of interest is analyzed to calculate a total volume of liquid during an overflow event. A further remedial action may be taken. In further examples, the remedial action taken may be a cessation of drilling operations.

Aspects of the technology additionally include a computer-implemented method. The computer implemented method may include receiving, by at least one computer processor, in situ fluid data related to a fluid flow of a drill rig. The method may further include determining, based at least in part on the in situ fluid data, to take an action.

In aspects of the technology, the action comprises changing at least one vision system parameter. In examples, the at least one vision system parameter selected from the group consisting of a number of fields of view, a number of regions of interest, a region of interest, a camera shutter speed, a number of light sources in use, a selection of light sources in use, and a type of light source in use.

In examples, the computer-implemented method further includes determining a first region of interest within a field of view based on shaker table features, wherein the first region of interest comprises image data. The method may further include determining, using a Deep Neural Network, an estimate of dryness of at least a portion the first region of interest. The computer-implemented method may also include determining to take an action is additionally based on, in part, an estimate of dryness. The action may comprise changing one or more operational parameters of a drill rig. The one or more operational parameters may include at least one of a pump speed, a valve position, a fluid rheology parameter, a temperature, or a pressure. The method may further include, determining, using the image data, a trend data of objects in an object flow. The method may further include to, based on the trend data, take further action. The trend data may comprise a change in volumetric distribution, particle size distribution, slurry shape or color distribution of the objects in an object flow.

### BRIEF DESCRIPTION OF THE DRAWINGS

Illustrative embodiments of the present invention are described in detail below with reference to the attached drawings, wherein:

FIG. 1 is an example environment in which the systems and methods described herein may operate.

FIG. 2 provides an example of a drill rig.

FIGS. 3A and 3B illustrate a shaker table employing a vision system to detect events such as an overflow event.

FIG. 4 is a method of detecting a wet event on the outflow end of a shaker table.

FIG. 5 is a method of estimating the overflow loss of a shaker table.

FIG. 6 is a method determining to take an action based on in situ fluid data.

FIG. 7 is a method for training a DNN model based on in situ data.

FIG. 8A is an example diagram of a distributed computing system 800 in which aspects of the present innovative technology, including the object imaging and detection engine described above, may be implemented.

Turning to FIG. 8B, one embodiment of the architecture of a system for performing the technology discussed herein is presented.

FIG. 9 illustrates an example computing environment on which aspects of the present disclosure may be implemented.

FIG. 10 is a block diagram illustrating additional physical components (e.g., hardware) of a computing device with which certain aspects of the disclosure may be practiced.

### DETAILED DESCRIPTION

In general, the terms and phrases used herein have their art-recognized meaning, which can be found by reference to standard texts, journal references, and contexts known to those skilled in the art. Aspects of the technology relate to determining whether an overflow event is imminent or already occurring. In some examples, this involves identifying whether a portion of a shaker table is relatively free from fluid. Additionally, data may be collected in situ instrumentation (e.g., measurements taken directly from the drilling fluid flow). In some instances, for example, it may be preferred that the portion of the shaker table toward the end of the table (e.g., the outlet stream) be relatively free of liquid. For some operations, wellbore conditions, and shaker table dimensions, it may be indicative of an imminent overflow event when approximately the last 15-33% of the shaker table evidences liquid.

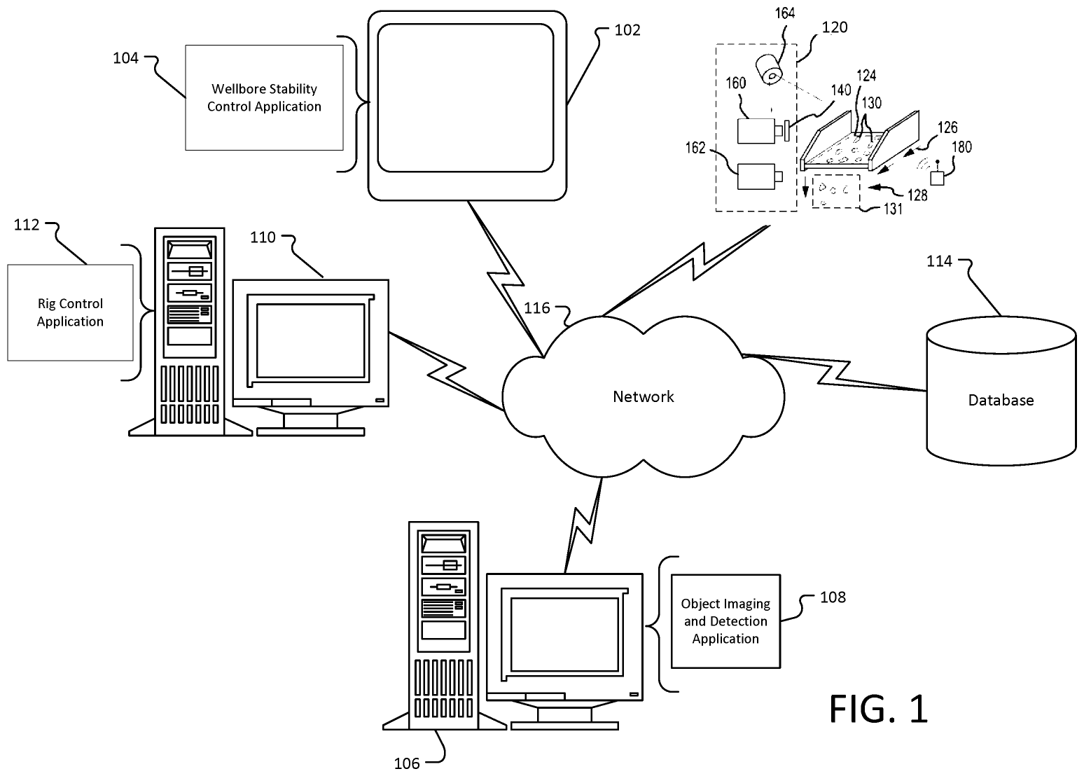

FIG. 1 is an example environment 100 in which the systems and methods described herein may operate. As illustrated, FIG. 1 includes a first computing device 102 storing a wellbore stability control application 104, a second computing device 106 storing an object imaging and detection application 108, and a third computing device 110 storing a rig control application 112. It will be appreciated that though each application is shown on a single computing device, the applications may be run on a single computer or more computers than as shown, as further described herein. Additionally illustrated is a storage device 114. Each of the first computing device 102, the second computing device 106, the third computing device 110, and the storage device 114 is in electronic communication via a network 116.

A wellbore stability control application 104 receives information from the object imaging and detection application 108, the rig control application 112, and/or the vision system 120 (referred hereinafter as System 100 data). The system data 100 may include in situ data gathered from various instrumentation, such as instruments that measure real-time fluid rheology, temperature, density, and pressure. Using some or all of the received information (e.g., the system data 100), the wellbore stability and control application 104 determines one or more wellbore operational parameters to adjust. This includes various MMSM parameters, such as shaker speed, vibration rate, screen size, rinse timer, etc. Determination may be based on an estimated likelihood of overflow, which may be calculated using the system data 100 as further described herein.

Additionally, using some or all of the received information (e.g., the system data 100), the wellbore stability and control application 104 may determine various wellbore features to report (such as an overflow event or the likelihood of an overflow event). In some examples, wellbore application 104 then sends information sufficient to adjust operational parameters, such as to prevent a wellbore overflow event, and/or update the predictive models. In aspects of the technology, wellbore application 104 sends a request to the rig control application 112 to make such adjustments. For example, based on the received information, the wellbore stability control application 104 may send signals to various pumps, valves, and/or hoppers, the control system of one or more MMSM, to change pump speed, actuate one or more valves, or add material to a fluid.

Object imaging and detection application 108 receives information from a vision system 120. In examples, image vision system 120, captures images having two regions of interest (“ROI”), namely a first ROI 124 and a second ROI 131. ROIs are areas within a field of view of an imaging device that are selected for image analysis, such as analysis by object detection using a Deep Neural Network (“DNN”) as further described herein. There may be one or more, such as two, three, four, five, etc., ROIs within a field of view. In aspects of the technology, an ROI is a portion of a captured image (e.g., the portion may be of a certain size within a field of view). Further, the portion of the ROI may be consistent over a period of time. The image data captured within the ROI may be associated with a time stamp corresponding to the time at which the image data was captured.

In some examples, image vision system 120 has one or more imaging devices. It will be appreciated that a single imaging device may be used to capture a large field of view from which one or more ROIs may be selected. As illustrated, the image vision system 120 has a first imaging device 160 and an optional second imaging device 162. Imaging devices, such as first imaging device 160 and optional second imaging device 162, may be any device suitable to capture images of objects in an object flow, including objects flowing through an MMSM. Such imaging devices include charge couple device (CCD) cameras, Complementary Metal Oxide Semiconductor cameras, high-resolution cameras, visible light cameras, low light or infrared cameras, and/or LiDAR imaging devices. In some applications, the vision system 120 may capture 3D profiles of objects in an object flow using one or more imaging devices that relate to LiDAR, stereo cameras, ultrasound sensors, or electromagnetic waves sensors, and/or other imaging devices now known or later developed capable of capturing 3D images.

Also illustrated is an additional light source 164. In aspects, one or more additional light sources 164 illuminates objects in an object flow (or other objects in a field of view), such as object flow 126. A light source may be an ultraviolet light, an incandescent light, a white light, tungsten light, infrared light, or light-emitting diodes (LEDs) to illuminate wellbore objects. The light source may be capable of generating various types of light, including near, mid, or far wave infrared lights, the visible spectrum, ultraviolet light, and the like.

The vision system 120 is illustrated in network communication with the various computing devices, such as a first computing device 102, a second computing device 106, and a third computing device 110. In aspects of the technology, the vision system 120 may transmit real-time information from imaging devices, including ROIs. In some aspects of the technology, the entire field of view is sent to a computing device 102 and/or a storage device 114. In other aspects, only the ROI is sent to the computing device 102 and/or the storage device 114. The image information may include wellbore object image information. The computing device 102 may be configured to process the image information. Such processing includes automatically identifying/classifying wellbore objects in the image as further described herein (e.g., using a DNN). The data related to identifying/classifying the objects in an object flow may be stored and used to identify operational trends.

It will be appreciated that various ancillary devices may be employed with image vision system 120 without deviating from the scope of the innovative technology. For example, various lenses, filters, enclosures, wipers, hoods, lighting, power supply, a cleaning system, brackets, and mounting devices may comprise image system 120. Further, one or more of a mechanical camera stabilizer, a camera fog stabilizer, or the like may be employed. Image system 120 may be designed to operate in outdoor, harsh, all-weather, hazardous areas, and/or 24 hours per day. The enclosure and its components may be watertight, explosion-proof, and/or intrinsically safe.

Vision system 120 also includes modification device 140. In examples, a modification device may be employed to modify/reduce/focus the light (e.g., infrared/visible light/ultraviolet light, etc.) captured from the objects in the object flow. For example, modification device 140 may be one or more of polarizers, filters, and/or beam splitters to intercept light reflected or emitted by the wellbore objects, such as well bore objects 130, and to reduce the amount/type of light received by the imaging devices of the vision system 120.

For example, the modification devices 140 may be chosen based on the type of drilling fluid that is used. Polarizers may be used to align light energy in either the P or S directions (so that the processed energy is p-polarized, or s-polarized) or to give a blend of P and S polarized energy. Beam splitters can be used to reduce the spectrum of the received energy to some selected range of wavelengths. Filters can be used to further narrow the range to a select spectrum prior to image capture.

Additionally/alternatively, one or more modification devices 140, may be interposed between the objects 130 and/or the object flow 126 and the vision system 120 to reduce the number of wavelengths captured by the vision system 120. In examples, the reduction in wavelengths allows fluid and objects that may be in close proximity to other objects to become relatively transparent so that the other objects in the object flow are more prominently captured by the image devices of the vision system 120.

The energy modification devices may be adjustable to obtain a relatively strong image contrast for the detection of the objects 130 within a fluid solution that has a dynamic composition. The selection of materials used in conjunction with the energy modification devices may depend on the hazards of the environment, including the chemical solutions present. These materials may include glass, polymers, and metals, among others.

In aspects of the technology, the images captured by vision system 120 include one or more ROIs. As illustrated, included is a first region of interest 124 and a second region of interest 131. The regions of interest may be selected to be a particular area of the MMSM, such as a falling zone of a shaker table or the entire MMSM. One or more ROIs may be selected and analyzed by an Object Imaging and Detection Application 108 to identify image aspects, including identifying objects in an object flow and identifying other objects in the ROI. Such identification may occur using a DNN. The region of interest may be automatically selected by the Object Imaging and Detection Application 108 as further provided herein. Further, though FIG. 1 illustrates identifying an ROI contemporaneous to the imaging devices capturing the image, it will be appreciated that an ROI may be determined after the image is captured. Such determination may be applied to historical data stored in a database, such as storage device 190.

One or more environmental sensors 180 may be part of the vision system 120 to aid in image rendering. The sensors may be used to detect the environment of the image capture area. For example, a first imaging device 160 may capture a portion of an MMSM that is experiencing a vibration due to the operation of the MMSM. The vibration rate may be captured by the one or more environmental sensors 180 and be automatically associated with the images captured by the imaging device at the time of capture. The environmental sensors 180 may capture other environmental factors, such as MMSM operation speed, load, light, and others. The data captured by environmental sensors 180 may be used to change/alter the selected ROI.

Rig control application 112 may be in electronic communication with various equipment, (e.g., valves, pumps, etc.) associated with a wellbore rig. Rig control application 112, in aspects, receives and stores information from sensors/devices associated with equipment of a drill rig and wellbore. Drill rig devices capture and transmit information related to downhole BHA tool or rig equipment, including the depth and positional information of the drill bit, Gamma Ray readings, wellbore volume, and pump flow rate during a drilling operation, stand pipe pressure, fluid density, etc.

The rig control application 112 and third computing device 110 may include supervisory control and data acquisition (SCADA) systems. The SCADA system is a control system architecture comprising software, computers, networked data communications, and graphical user interfaces (GUI) for high-level process supervisory management, while also comprising other peripheral devices like programmable logic controllers (PLC), decentralized control system (DCS), model predictive controller (MPC) and discrete proportional-integral-derivative (PID) controllers to interface with the managed pressure drilling (MPD) and drilling rig's equipment. The SCADA hardware may execute software that will combine data from multiple sources and perform continuous optimization of the MPD controller setpoints and tuning parameters. The model predictive controller (MPC) may be running within the SCADA software architecture or on a separate controller and using the SCADA communication architecture to get and provide updated parameters. Circulating drilling fluid may transport rock fragments out of a wellbore. The rig control application 112 may use object information obtained from image data, data acquired by an MPD data acquisition (DAQ), and rig data acquisition to enable the SCADA system to determine the choke pressure, hookload, flow, torque, weight-on-bit (WOB), rate of penetration (ROP), rheology, and directional sensor information. These may be used to provide feedback and control to the drilling/pumping and MPD devices as well as generate monitoring information and alerts. The rig control application 112 receives, in aspects, control requests and model updates from the wellbore stability control application 104.

As illustrated, a storage device 114 is in electronic communication with the first computing device 102, the second computing device 106, the third computing device 110 via the network 116. The storage device 114 may be used to store acquired image and computational data, as well as other data in memory and/or a database. For example, the storage device 114 may store images captured by imaging devices along with associated data, such as the time of capture. Further, sensor data and other information may be associated with the image in a relational database or other databases. The object imaging and detection application 108 may retrieve such stored data for a variety of purposes. For example, as described further herein, the object imaging and detection application 108 may set new ROIS on an image that was captured in the past. The object imaging and detection application 108 may use image data stored on the storage device 190 to retrieve the historical image and/or a portion of the historical image data, including historical image data associated with the newly set ROI. Further, the storage device may store predictive modeling outputs from the rig control application 112c.

The network 116 facilitates communication between various computing devices, such as the computing devices illustrated in FIG. 1. Network 116 may be the Internet, an intranet, or another wired or wireless communication network. For example, the communication network 116 may include a GLOBAL Mobile Communications (GMS) network, a code division multiple access (CDMA) network, 3^{rd} Generation Partnership Project (GPP) network, an Internet Protocol (IP) network, a wireless application protocol (WAP) network, a Wi-Fi network, a satellite communications network, or an IEEE 802.11 standards network, as well as various communications thereof. Other conventional and/or later developed wired and wireless networks may also be used.

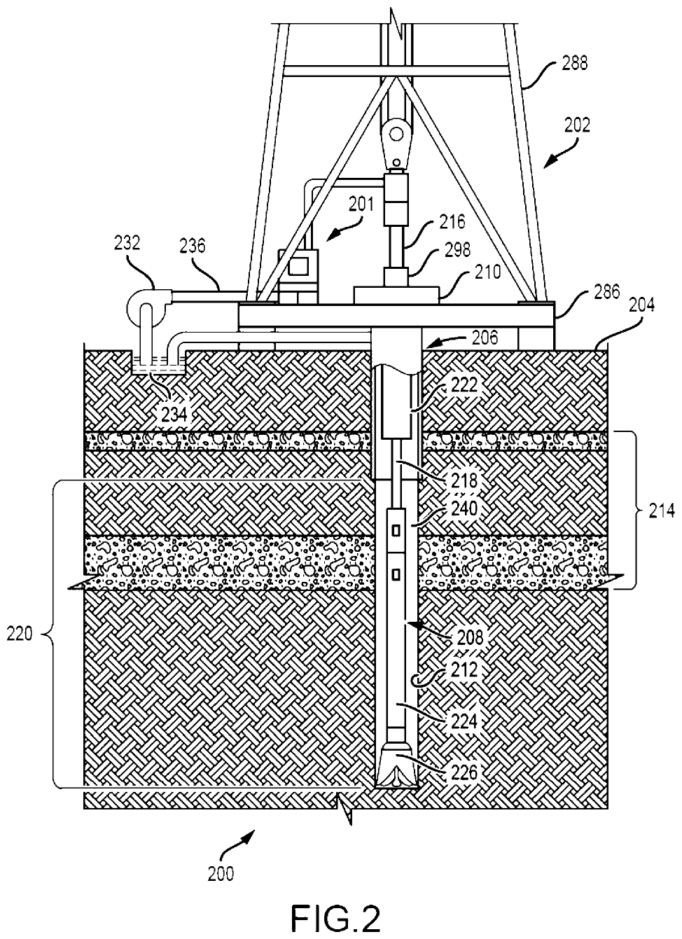

FIG. 2 provides an example of a drill rig 200, in which equipment and devices may be monitored and controlled by the various technologies described herein, including a rig control application described and a wellbore stability control application. Rig 202 may be located at the surface 204 of a well 206. Drilling of oil, gas, and geothermal wells is commonly carried out using a string of drill pipes or casings connected to a drilling string 208 that is lowered through a rotary table 210 into a wellbore or borehole 212. Here a drilling platform 286 is equipped with a derrick 288 that supports a hoist.

As illustrated, the drilling rig of 202 provides support for the drill string 208. The drill string 208 may operate to penetrate the rotary table 210 for drilling the borehole 212 through subsurface formations 214. The drill string 208 may include a Kelly 216, drill pipe 218, and a bottom hole assembly 220, perhaps located at the lower portion of the drill pipe 218.

The bottom hole assembly (BHA) 220 may include drill collars 222, a downhole tool 224, and a drill bit or float equipment 226 attached to casings for cementing. The drill bit or float equipment 226 may operate to create a borehole 212 by penetrating the surface 204 and subsurface formations 214. The downhole tool 224 may comprise any of a number of different types of tools, including Measurement While Drilling (“MWD”) tools, Logging while drilling (“LWD”) tools, casing tools, and cementing tools, and others.

During drilling operations, the drill or casing string 208 (perhaps including the Kelly 216, the drill or casing pipe 218, and the bottom hole assembly 220) may be rotated by the rotary table 210. In addition to, or alternatively, the bottom hole assembly 220 may also be rotated by a motor (e.g., a mud motor) that is located down hole. The drill collars 222 may be used to add weight to the drill bit or float equipment 226.

The drill collars 222 may also operate to stiffen the bottom hole assembly 220, allowing the bottom hole assembly 220 to transfer the added weight to the drill bit and in turn, to assist the drill bit in penetrating the surface 204 and subsurface formations 214.

During drilling and pumping operations, a pump 232 may pump fluids (sometimes known by those of ordinary skill in the art as “drilling mud,” “cement,” “pills,” “spacers,” “sweeps,” “slugs”) from a processing pit 234 through a hose 236 into the drill pipe or casing 218 and down to the drill bit float equipment 226. In operation, the fluid may flow out from the drill bit or float equipment 226 and be returned to the surface 204 through an annular area 240 (e.g., an annulus) between the drill pipe or casing 218 and the sides of the wellbore borehole 212. The fluid may then be returned to the processing pit 234, where such fluid is processed (e.g., filtered). In some embodiments, the fluid can be used to cool the drill bit 226, as well as to provide lubrication for the drill bit 226 during drilling operations. Additionally, the fluid can be used to cement the wellbore and case off the sub-surface formation 214. Additionally, the fluid may be used to remove other fluid types (e.g., cement, spacers, and others), including wellbore objects such as subsurface formation 214 objects created by operating the drill bit 226 and equipment failures.

The fluid circulated down the wellbore 212 to the processing pit 234 and back down the wellbore 212 has a density. Various operational parameters of the drill rig 200 may be controlled. For example, the density of the fluid, the flow rate of the fluid, and the pressure of the wellbore 212 may be controlled. Control of the various operational parameters may be accomplished using a computing system 201, which may run/store (or be in electronic communication with) a wellbore stability control application and/or a rig control application as described herein. The drill rig, equipment, bit, and other devices may be equipped with various sensors to monitor the operational performance of the rig, and these sensors may be in electronic communication with the computing system 201. In aspects of the technology, computing system 201 is the same or similar to the third computing device 110 described above with reference to FIG. 1.

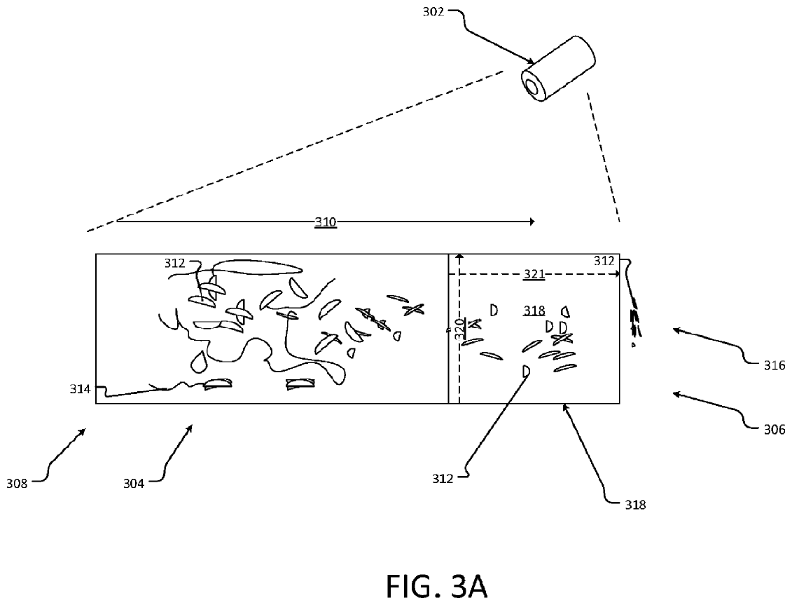

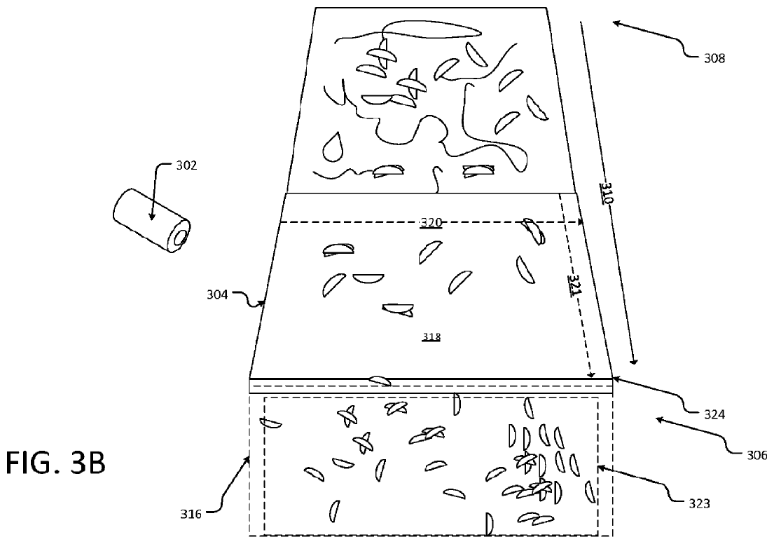

FIG. 3A illustrates a top view and FIG. 3B illustrates an orthogonal view of a shaker table 304, at which an imaging device 302 is directed. As illustrated, shaker table 304 has an output end 306, and an input end 308. Flow 310 of drilling output (e.g., drilling fluid, cuttings, shaving, debris, and/or other items) flows from the input end 308 toward the output end 306. Objects 312 are present, as is drilling fluid 314. An imaging device 302 may capture some or all of a portion of the surface shaker table 304. The imaging device 302 may also capture some or all of the falling zone 316.

A predetermined area 318 having a height 320 and a width 321 may also be identified. The predetermined area 318 may be determined based on the make and or manufacture of the shaker table. For example, a database, such as storage device 114 may store various dimensions of an area near the output end 306 of a shaker table that should be relatively dry during typical operations of drilling. In examples, the shape is a rectangle having a height 320 and a width 321, though other shapes may be contemplated.

In examples, imaging device 302 may capture a field of view that includes the predetermined area 318. The predetermined area may be selected from the image data captured by the imaging device 302 for analyzing. For example, it may be desirous to identify whether the predetermined area 318 is wet or dry. Such analysis may occur using a DNN, such as the DNNs and associated vision systems as further described herein.

Additionally, an ROI may be determined at the falling zone of the shaker table. In examples, the portion of the falling zone 323 is selected for analysis. For example, ROI 323 may be selected for analysis. In examples, the size, volume, rate of volume of fluid, cuttings, cavings, and/or other items may be identified.

In some examples, a conversion must be made to appropriately identify the image data of the captured image that corresponds to the predetermined area. This may occur, for example, by the imaging device capturing an image of the shaker table. In some examples, the image may be captured at an angle. In some instances, one or more objects are used to identify the predetermined area as an ROI. For example, the length of the edge compared to the length of the shaker table at a known distance away from the edge may be used to identify the angle at which the image device 302 was capturing the image of the shaker table. This may be used to identify a number of pixels and shape of an ROI of the predetermined area for analysis. One advantage to limiting the ROI to the predetermined area is that it helps reduce processing requirements and data transport requirements related to analyzing the ROI (for moisture content and presence, for example).

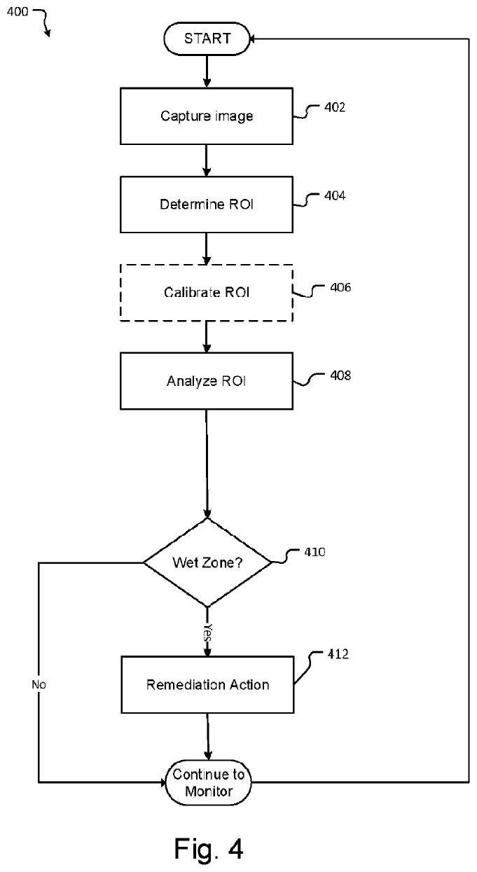

FIG. 4 is a method 400 of detecting an increased likelihood of an overflow event at a shaker table by capturing image data of a predetermined region of an MMSM that, during typical operations, should be relatively free of fluid. Method 400 begins with operation 402. In operation 402, a field of view of an MMSM is captured. In aspects, the field of view is of some or all of a shaker screen of a shaker table. In some aspects, an image capture device, similar to the image capture devices described herein, is used to capture the image having image data. In aspects, the image is taken at an angle directly above the shaker table. In additional/alternative aspects, the image is taken at an angle, such as 80 degrees, 45 degrees, or other angle to the shaker table. In some examples, a falling zone of the MMSM is captured as well.

Method 400 then proceeds to determine a region of interest operation 404. In operation 404 a region of interest is determined. For example, the region of interest may be a predetermined area of a shaker screen of an MMSM. For example, it may be determined that a portion of a shaker screen should remain relatively dry (e.g., free from drilling fluid) at the last 30%, 20%, 15%, or 10% of the MMSM. In such scenarios, the ROI may be determined as the last 30%, 20%, 15%, or 10% of the MMSM. In other cases, the portion is manually selected by a user, or information concerning the actual equipment in use is retrieved from a database and used to automatically set the distance or fraction of the device that should be relatively free of liquid.

Method 400 then optionally proceeds to calibrate ROI operation 406. In operation 406, the ROI pixel size and shape may be calibrated against one or more known objects and dimensions in a field of view. For example, a ledge of a falling zone, marking on an MMSM, or other object may be used to determine the size and shape of the ROI determined at operation 404. The result may include an ROI having a height, width, and other shape. For example, an image capture device captured the image of the shaker table at an angle, a trapezoidal shape may be the closest map to capture the last portion of the shaker table.

Method 400 then proceeds to analyze ROI operation 408. In aspects of the technology, the ROI is analyzed using a DNN to determine whether drilling fluid appears in the ROI selected in operation 404 (a wet event). The DNN, for example, may have been trained to detect fluid presence on a screen.

Method 400 then proceeds to determination 410. In determination 410, if fluid is detected, method 400 proceeds to take a remediation action operation 412. In examples, the remediation may be one of an alarm, sending a shutdown signal, sending a command to change an operational parameter, display an alert, and the like. If the remedial action is successful, drilling operations can continue. If no fluid is detected, the method repeats and continues to monitor.

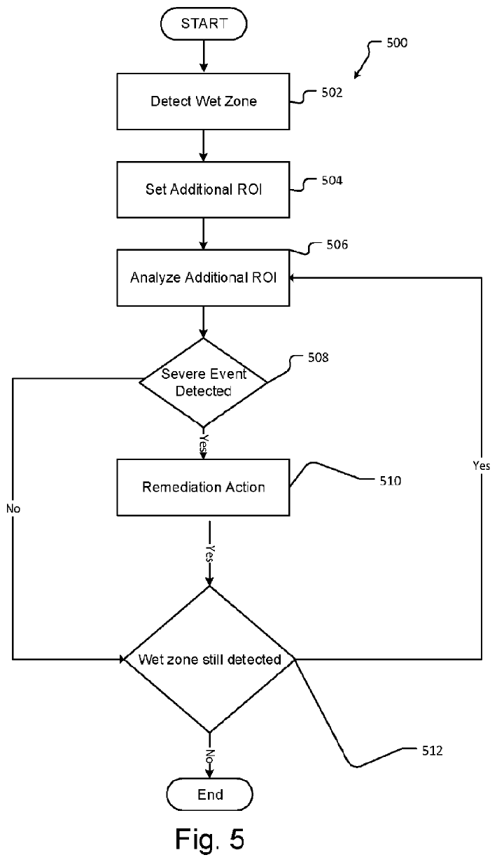

FIG. 5 illustrates a method 500 for analyzing an additional ROI in a falling zone based on an actual overflow event. Method 500 begins with detecting a wet event operation 502. In aspects of the technology, a wet event may be detected using various methods, such as method 400 as described above. For example, a predetermined area of an MMSM may be detected as wet.

Method 500 then proceeds to identify additional ROI operation 504. In aspects of the technology, one or more additional ROIs may be identified and set. For example, an ROI in the falling zone of an MMSM may be set. The ROIs may be both historical and future image data. In additional examples, the additional ROI is set downstream and/or upstream from the initial ROI selected.

Method 500 then proceeds to analyze additional ROI operation 506. In operation 506, the one or more additional ROIs identified and set in operation 504 are analyzed. In aspects of the technology, the one or more ROIs may be analyzed using a DNN to determine whether an overflow event has occurred and the volume of liquid that has spilled until overflow and/or wet event in a predetermined area is no longer detected. For example, the size, volume, rate of volume, of fluid, cuttings, cavings, and/or other items may be identified in the additional ROI.

Method 500 then proceeds to severe event detected determination 510. In determination 510, it is determined whether a severe event (such as an overflow) has been detected using the information from operation 506. If a severe event is detected, method 500 proceeds to remediation action 510. In remediation action 510, an action such as shutdown pumps, sound alarm, send alert, close valves, etc., is initiated.

If no severe event is detected at determination 508 and after remediation action 510, method 500 proceeds to determination 512, where a check is made to see if a wet zone in a predetermined area is still occurring (for example, using the method described in FIG. 4 above). If it is, the method loops back to operation 506. If not, the method ends.

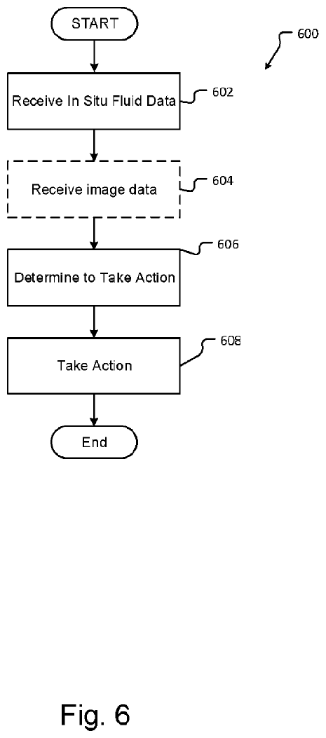

FIG. 6 is a method 600 for determining to take an action based on, at least in part in situ fluid data. Method 600 begins with receive in situ fluid data operation 602. In operation 602, data is received by at least one computer processor. In some aspects of technology, one or more instruments capture fluid information in situ in the fluid flow. Such instruments include instruments to track the rheology, density, and temperature of drilling fluid.

Method 600 then optionally proceeds to receive image data operation 604. In operation 604, image data from one or more vision systems, such as the vision systems described above, may be used in combination with the in situ data to determine to take an action.

Method 600 then proceeds to determine to take action operation 606. In operation 606, one or more computer processors determine to take an action based on, at least in part, the received in situ data and, optionally, the image data. For example, determining to take an action may result from one or more computer processors analyzing the in situ data and/or the image data. In situ fluid data includes, in some examples, information regarding the flow rate of fluid, pressure of fluid at various points in the drilling operation, number of suspended objects, viscosity of the fluid, etc. Additionally, image data may include the number of objects, type of object, volume of objects, shape of objects, color of objects, etc.

Determinations may be based on using this and other information to determine a deviation from a predicted value. Additionally, determinations may be based on trends. For example, a steady increase in pressure captured from in situ instrumentation may indicate the potential for an overflow event. Such information may be combined with an observation that the % of dry area is increasing over time as well. Trend data may also include steady or rapid changes in volumetric distribution, particle size distribution, slurry shape and/or color distribution of the objects in an object flow.

Method 600 then proceeds to take action operation 608. In operation 608, an action is taken. For example, such action may be to change to a vision system, such as the vision systems described above. For example, an action may be a change to a vision system parameter. Such vision system parameters include the number of fields of view, the number of regions of interest, the region of interest, camera shutter speed, the number of light sources in use, a selection of light sources in use, and a type of light source in use. The change may occur when a computer processor sends a control signal to one more devices (e.g., a camera, a light switch, etc.), software applications, and/or control systems to cause such change.

As a specific example, an action may change a region of interest of a vision system. As further described herein, The new region of interest may be further analyzed to determine, using a DNN, an estimate of dryness of at least a portion of the first region of interest. Such information may be used to get further information regarding the likelihood of an overflow event.

Additionally, one or more operational parameters may be changed based on, in part, the in situ data. Such drilling operational parameters include a pump speed, a valve position, a fluid rheology parameter, a temperature, or a pressure. Changes may occur by sending a request or control signal to various devices, software applications, and/or control systems.

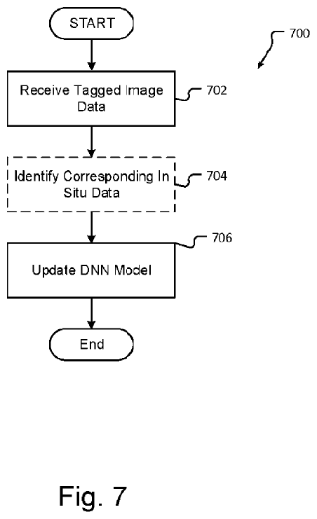

FIG. 7 is a method 700 for training a DNN model based on in situ data. In examples, a DNN associated with a vision system, such as the vision systems described above, may be augmented with additional data from in situ instrumentation. Method 700 begins with received tagged image data operation 702. In operation 702, images associated with a high likelihood of an overflow event (e.g., during an overflow occurrence, right before an occurrence and/or right after an occurrence) are provided to a DNN. The image data may be tagged as indicative of an overflow occurring when a user interacts with a graphic user interface to tag the image. Additionally/alternatively, image data may be automatically tagged by identifying image data that corresponds to a time when an overflow event was detected by sensors or other means. This may occur by a rig control application and/or a rig wellbore stability control application receiving an instrument signal associated with an overflow event (e.g., a moisture or level control signal indicative of an overflow).

Method 700 then proceeds to gather in situ data operation 704. In operation 704, corresponding in situ data associated with the overflow event (including data gathered before, after, and during overflow) is collected. For example, the tagged image data relating to an overflow event (e.g., during, before, or after an overflower event) may be associated with a time stamp. In situ data may be gathered from a time temporally proximate to that timestamp. Proximate may include a few seconds, milliseconds, several seconds, several minutes, and/or many minutes. It will be appreciated that relevant in situ data may depend on the size of the drilling pipe, depth, fluid flow rate, signal delay time, and the like.

Method 700 then proceeds to update the DNN model operation 706. During update operation 706, the DNN is trained to associate certain patterns in the image data with the in situ data being indicative of an overflow event. For example, the DNN may be trained to recognize an overflow event using both image data and in situ data (such as a rapid change in the temperature of the drilling fluid). In an example, a late fusion technique may be employed. For example, a DNN may use separate branches to process the image and the in situ information. In further examples, a DNN may use the image to detect features indicative of an overflow event, while a simpler neural network branch processes whether a temperature surge (or other in situ data associated with an overflow event) is occurring proximate in time. These two branches may, in examples, operate independently at first, allowing the network to extract relevant features from both the visual and contextual modalities. The data sets may be combined using various techniques, such as concatenation. The combined data may then pass through additional layers of the network, culminating in the output layer, where the decision about the presence of an overflow event is made. This approach may, in examples, allow the DNN to leverage in situ data that indicate a higher likelihood of an overflow event taking place, thereby enhancing the accuracy of overflow detection. Training the DNN may also involve adjusting weights across both the image-processing and in situ data-processing branches, encouraging the model to optimally use all available data to improve its predictions.

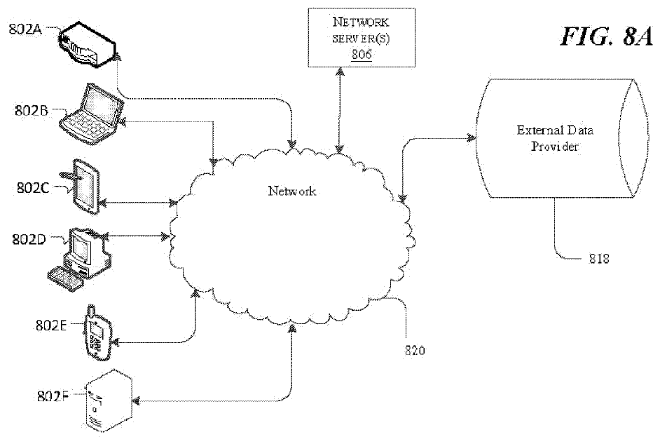

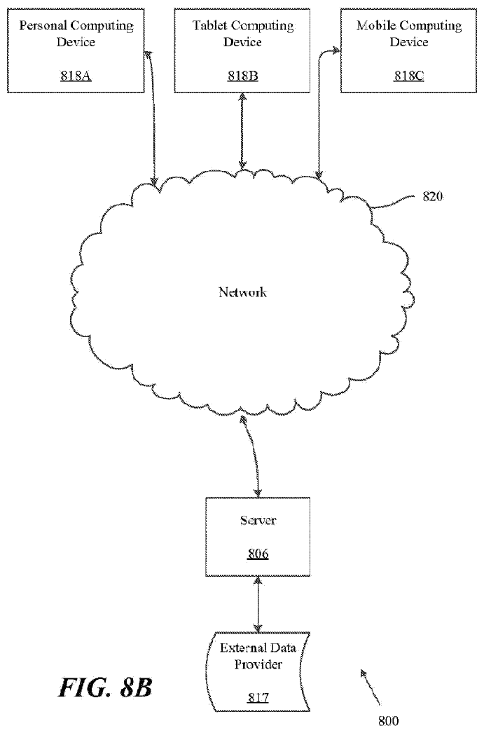

FIG. 8A is an example diagram of a distributed computing system 800 in which aspects of the present innovative technology, including the object imaging and detection engine described above, may be implemented. According to examples, any computing devices, such as a modem 802A, a laptop computer 802B, a tablet 802C, a personal computer 802D, a smartphone 802E, and a server 802F, may contain engines, components, moduals, etc., for controlling the various equipment associated with image capture and detection. Additionally, according to aspects discussed herein, any of the computing devices may contain the necessary hardware for implementing aspects of the disclosure. Any and/or all of these functions may be performed, by way of example, at network servers and/or when computing devices request or receive data from external data providers by way of a network 820.

Turning to FIG. 8B, one embodiment of the architecture of a system for performing the technology discussed herein is presented. Content and/or data interacted with, requested, and/or edited in association with one or computing devices may be stored in different communication channels or other storage types. For example, data may be stored using a directory service, a web portal, a mailbox service, an instant messaging store, or a compiled networking service for image detection and classification. The distributed computing system 800 may be used for running the various engines to perform image capture and detection, such as those discussed with reference to FIG. 4. The computing devices 818A, 818B, and/or 818C may provide a request to a cloud/network 820, which is then processed by a network server 806 in communication with an external data provider 817. By way of example, a client computing device may be implemented as any of the systems described herein and embodied in the personal computing device 818A, the tablet computing device 818B, and/or the mobile computing device 818C (e.g., a smartphone). Any of these aspects of the systems described herein may obtain content from the external data provider 817.

In various examples, the types of networks used for communication between the computing devices that make up the present invention include but are not limited to, the Internet, an intranet, wide area networks (WAN), local area networks (LAN), virtual private networks (VPN), GPS devices, SONAR devices, cellular networks, and additional satellite-based data providers such as the Iridium satellite constellation which provides voice and data coverage to satellite phones, pagers, and integrated transceivers, etc. According to aspects of the present disclosure, the networks may include an enterprise network and a network through which a client computing device may access an enterprise network. According to additional aspects, a client network is a separate network accessing an enterprise network through externally available entry points, such as a gateway, a remote access protocol, or a public or private Internet address.

Additionally, the logical operations may be implemented as algorithms in software, firmware, analog/digital circuitry, and/or any combination thereof, without deviating from the scope of the present disclosure. The software, firmware, or similar sequence of computer instructions may be encoded and stored upon a computer-readable storage medium. The software, firmware, or similar sequence of computer instructions may also be encoded within a carrier-wave signal for transmission between computing devices.

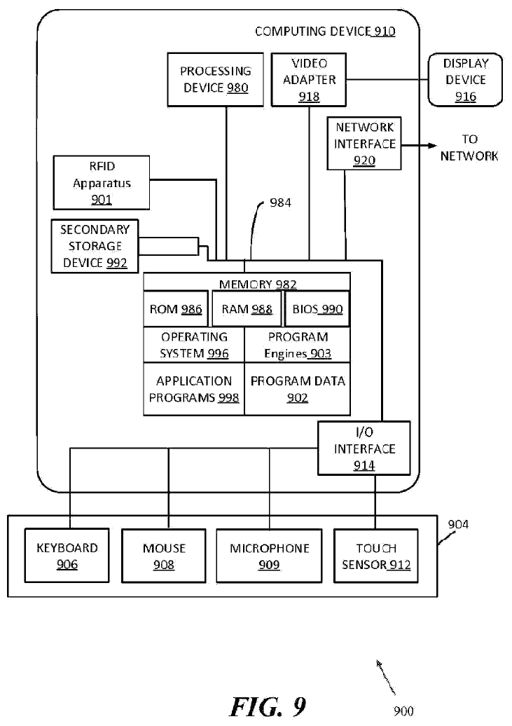

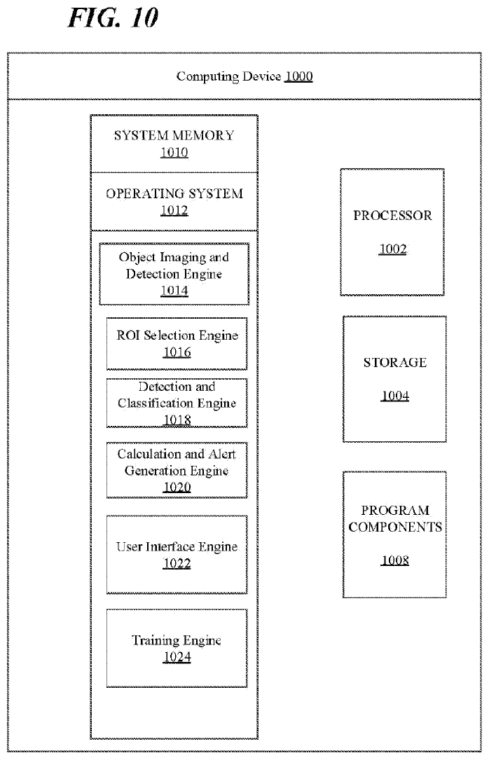

Operating environment 900 typically includes at least some form of computer-readable media. Computer-readable media can be any available media that can be accessed by a processor such as processing device 980 depicted in FIG. 9 and processor 1002 shown in FIG. 10 or other devices comprising the operating environment 900. By way of example, and not limitation, computer-readable media may comprise computer storage media and communication media.

Computer storage media includes volatile and nonvolatile, and removable and non-removable media implemented in any method or technology for storage of information such as computer-readable instructions, data structures, program engines, or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer-readable instructions, data structures, program engines, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

The operating environment 900 may be a single computer operating in a networked environment using logical connections to one or more remote computers. The remote computer may be a personal computer, a GPS device, a monitoring device such as a static-monitoring device or a mobile monitoring device, a pod, a mobile deployment device, a server, a router, a network PC, a peer device, or other common network nodes, and typically includes many or all of the elements described above as well as others not so mentioned. The logical connections may include any method supported by available communications media. Such networking environments are commonplace in enterprise-wide computer networks, intranets, and the Internet.

FIG. 10 illustrates one aspect of a computing system 1000 that may be used to implement aspects of the present disclosure, including any of the plurality of computing devices described herein with reference to the various figures and their corresponding descriptions. The computing device 1000 illustrated in FIG. 10 can be used to execute an operating system 996, application programs 998, and program engines 903 (including the engines described with reference to FIG. 4) described herein.

The computing device 910 includes, in some embodiments, at least one processing device 980, such as a central processing unit (CPU). A variety of processing devices are available from a variety of manufacturers, for example, Intel, Advanced Micro Devices, and/or ARM microprocessors. In this example, the computing device 910 also includes a system memory 982, and a system bus 984 that couples various system components including the system memory 982 to the at least one processing device 980. The system bus 984 is one of any number of types of bus structures including a memory bus, or memory controller; a peripheral bus; and a local bus using any of a variety of bus architectures.

Examples of devices suitable for the computing device 910 include a server computer, a pod, a mobile-monitoring device, a mobile deployment device, a static-monitoring device, a desktop computer, a laptop computer, a tablet computer, a mobile computing device (such as a smartphone, an iPod® or iPad® mobile digital device, or other mobile devices), or other devices configured to process digital instructions.

Although the exemplary environment described herein employs a hard disk drive or a solid state drive as a secondary storage device, other types of computer-readable storage media are used in other aspects according to the disclosure. Examples of these other types of computer-readable storage media include magnetic cassettes, flash memory cards, digital video disks, Bernoulli cartridges, compact disc read-only memories, digital versatile disk read-only memories, random access memories, or read-only memories. Additional aspects may include non-transitory media. Additionally, such computer-readable storage media can include local storage or cloud-based storage.

A number of program engines can be stored in the secondary storage device 992 or the memory 982, including an operating system 996, one or more application programs 998, other program engines 903 (such as the software engines described herein), and program data 902. The computing device 910 can utilize any suitable operating system, such as Linux, Microsoft Windows™, Google Chrome™, Apple OS, and any other operating system suitable for a computing device.

According to examples, a user provides inputs to the computing device 910 through one or more input devices 904. Examples of input devices 904 include a keyboard 906, a mouse 908, a microphone 909, and a touch sensor 912 (such as a touchpad or touch-sensitive display).

Additional examples may include input devices other than those specified by the keyboard 906, the mouse 908, the microphone 909, and the touch sensor 912. The input devices are often connected to the processing device 980 through an input/output (I/O) interface 914 that is coupled to the system bus 984. These input devices 904 can be connected by any number of I/O interfaces 914, such as a parallel port, serial port, game port, or universal serial bus. Wireless communication between input devices 904 and the interface 914 is possible as well and includes infrared, BLUETOOTH® wireless technology, cellular, and other radio frequency communication systems in some possible aspects.

In an exemplary aspect, a display device 916, such as a monitor, liquid crystal display device, projector, or touch-sensitive display device, is also connected to the computing system 910 via an interface, such as a video adapter 918. In addition to the display device 916, the computing device 910 can include various other peripheral devices, such as speakers or a printer.

When used in a local area networking environment or a wide area networking environment (such as the Internet), the computing device 910 is typically connected to a network such as network 820 shown in FIGS. 8A and 8B through a network interface, such as an Ethernet interface. Other possible embodiments use other communication devices. For example, certain aspects of the computing device 910 may include a modem for communicating across the network. The computing device 910 typically includes at least some form of computer-readable media. Computer-readable media includes any available media that can be accessed by the computing device 910. By way of example, computer-readable media include computer-readable storage media and computer-readable communication media.

The computing device 910 illustrated in FIG. 9 is also an example of programmable electronics, which may include one or more such computing devices, and when multiple computing devices are included, such computing devices can be coupled together with a suitable data communication network so as to collectively perform the various functions, methods, or operations disclosed herein.

FIG. 10 is a block diagram illustrating additional physical components (e.g., hardware) of a computing device 1000 with which certain aspects of the disclosure may be practiced. Computing device 1000 may perform these functions alone or in combination with a distributed computing network such as those described with regard to FIGS. 8A and 8B which may be in operative contact with personal computing device 818A, tablet computing device 818B, and/or mobile computing device 818C which may communicate and process one or more of the program engines described herein.

In a basic configuration, the computing device 1000 may include at least one processor 1002 and a system memory 1010. Depending on the configuration and type of computing device, the system memory 1010 may comprise, but is not limited to, volatile storage (e.g., random access memory), non-volatile storage (e.g., read-only memory), flash memory, or any combination of such memories. The system memory 1010 may include an operating system 1012 and one or more program engines 1014. The operating system 1012, for example, may be suitable for controlling the operation of the computing device 1000. Furthermore, aspects of the disclosure may be practiced in conjunction with a graphics library, other operating systems, or any other application program and are not limited to any particular application or system.

The computing device 1000 may have additional features or functionality. For example, the computing device 1000 may also include an additional data storage device (removable and/or non-removable) such as, for example, magnetic disks, optical disks, or tape. Such additional storage is illustrated in FIG. 10 by storage 1004. It will be well understood by those of skill in the art that storage may also occur via the distributed computing networks described in FIG. 8A and FIG. 8B. For example, the computing device 1000 may communicate via network 820 in FIG. 8A and data may be stored within network servers 806 and transmitted back to computing device 1000 via network 820 if it is determined that such stored data is necessary to execute one or more functions described herein. Additionally, computing device 1000 may communicate via network 820 in FIG. 8B and data may be stored within network server 806 and transmitted back to computing device 1000 via a network, such as network 820, if it is determined that such stored data is necessary to execute one or more functions described herein.

As stated above, a number of program engines and data files may be stored in the system memory 1010. While executing the at least one processor 1002, the program engines 1014 (e.g., the engines described with reference to FIG. 4) may perform processes including, but not limited to, the aspects described herein.

While various embodiments and examples have been described for purposes of this disclosure, various changes and modifications may be made which are well within the scope of the disclosed methods. Numerous other changes may be made which will readily suggest themselves to those skilled in the art and which are encompassed in the spirit of the disclosure.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components and individual functions can be distributed among different components. In this regard, any number of the features of the different embodiments described herein may be combined into one single embodiment and alternate embodiments having fewer than or more than all of the features herein described as possible.

What is claimed:

1. A computer-implemented method comprising:
capturing a field of view of a MMSM using an image capture device,
determining a first region of interest within the field of view based on shaker table features, wherein the first region of interest comprises image data;
determining, using a Deep Neural Network, whether the image data indicates the region captured by the first region of interest is relatively dry; and
taking an action based on the determining of whether the image data indicates the region is relatively dry or flooded.

2. The computer-implemented method of claim 1, wherein determining whether the image data indicates the region is relatively dry comprises determining that the region is not relatively dry; and further wherein taking an action comprises taking a remedial action.

3. The computer-implemented method of claim 2, wherein the remedial action is selected from the group consisting of sounding an audible alarm, setting a visual alarm, sending an error message, sending a control signal to initiate a spray wash, sending a control signal to initiate a spray wash pressure, washing screens, changing pump rate, changing a fluid property, sending a message indicating to change screen size, type, or replace screens.

4. The computer-implemented method of claim 1, wherein determining the first region of interest comprises identifying an object in the region of interest with a known dimension, correlating the known dimension to a number of pixels, and selecting the first region of interest to be a first number of pixel in height and a second number of pixels in length based on the correlation.

5. The computer-implemented method of claim 1, wherein the first region of interest dimensions are determined from pre-existing data.

6. The computer-implemented method of claim 5, wherein the pre-existing data was received by a user entering information into a graphical user interface of a computing device.

7. The computer-implemented method of claim 5, further comprising capturing another region of interest.

8. The computer-implemented method of claim 7, wherein the other region of interest is a falling zone of an MMSM.

9. The computer-implemented method of claim 8 wherein the other region of interest is analyzed to calculate a total volume of liquid during an overflow event.

10. The computer implemented method of claim 8 wherein further remedial action is taken.

11. The computer implemented method of claim 10 wherein the remedial action taken is cessation of drilling operations.

12. A computer-implemented method comprising: receiving, by at least one computer processor, in situ fluid data related to a fluid flow of a drill rig; determining, based at least in part on the in situ fluid data, to take an action.

13. The computer-implemented method of claim 12, wherein the action comprises changing at least one vision system parameter.

14. The computer-implemented method of claim 13, wherein the at least one vision system parameter selected from the group consisting of: a number of fields of view, a number of regions of interest, a region of interest, a camera shutter speed, a number of light sources in use, a selection of light sources in use, and a type of light source in use.

15. The computer-implemented method of claim of 14, further comprising: determining a first region of interest within a field of view based on shaker table features, wherein the first region of interest comprises image data; determining, using a Deep Neural Network, an estimate of dryness of at least a portion the first region of interest.

16. The computer-implemented method of claim 16, wherein determining to take an action is additionally based on, in part, an estimate of dryness.

17. The computer-implemented method of claim 12, wherein the action comprises changing one or more operational parameters of a drill rig.

18. The computer-implemented method of claim 17, wherein the one or more operational parameters include at least one of a pump speed, a valve position, a fluid rheology parameter, a temperature, or a pressure.

19. The computer-implemented method of claim 15, further comprising:
determining using the image data, a trend data of objects in an object flow, and based on the trend data, taking a further action.

20. The computer implemented method of claim 19, where trend data comprises a change in volumetric distribution, particle size distribution, slurry shape or color distribution of the objects in an object flow.
